(19) United States
(12) Patent Application Publication
(10) Pub. No.: US 2019/0107210 A1
(43) Pub. Date: Apr. 11, 2019

(54) SPOOL VALVE

(71) Applicant: Robert Bosch GmbH, Stuttgart (DE)

(72) Inventors: Bernd Berghaenel, Illingen (DE); Peter Stachnik, Markgroeningen (DE); Sophie-Charlotte Deger-Panthene, Stuttgart (DE); Stephan Wehr, Heiligenstadt (DE)

(21) Appl. No.: 16/087,735

(22) PCT Filed: Mar. 8, 2017
(86) PCT No.: PCT/EP2017/055386

§ 371 Date: Sep. 24, 2018

(30) Foreign Application Priority Data
Mar. 24, 2016 (DE) 10 2016 205 041.9

(51) Int. Cl. F16K 3/26; F02G 5/02

(52) U.S. Cl. CPC F16K 3/267; F01K 23/065; F02G 5/02

(57) ABSTRACT

The invention relates to a spool valve (1), having a valve housing (4) and a substantially axially symmetric closing body (3) arranged for longitudinal movement in the valve housing (4). An inlet channel (5), a first outlet channel (6a), and a second outlet channel (6b) are formed in the valve housing (4). The closing body (3) interacts with a first valve seat (8a) formed in the valve housing (4) by means of the longitudinal movement of the closing body and thereby opens and closes a first hydraulic connection between the inlet channel (5) and the first outlet channel (6a). Furthermore, the closing body (3) interacts with a second valve seat (8b) formed in the valve housing (4) by means of the longitudinal movement of the closing body and thereby opens and closes a second hydraulic connection between the inlet channel (5) and the second outlet channel (6b). The resulting hydraulic force on the closing body (3) in the axial direction is nearly zero.

### BACKGROUND OF THE INVENTION

The invention relates to a slide valve. The slide valve according to the invention may be used in particular in a waste-heat recovery system of an internal combustion engine.

Valves are known in a wide variety of embodiments from the prior art.

A known slide valve comprises a valve housing and a substantially axially symmetrical closing body arranged in longitudinally movable fashion in the valve housing. An inlet duct, a first outlet duct and a second outlet duct are arranged in the valve housing. The closing body, by means of its longitudinal movement, interacts with a first valve seat formed on the valve housing and thereby opens and closes a first hydraulic connection to the first outlet duct. Furthermore, the closing body, by means of its longitudinal movement, interacts with a second valve seat formed on the valve housing and thereby opens and closes a second hydraulic connection to the second outlet duct. A valve of said type is known for example from the application DE 10 2014 224979 A1, which does not constitute a prior publication.

The closing body of the known slide valve requires relatively high forces for the actuation of the closing body.

### SUMMARY OF THE INVENTION

The slide valve according to the invention can, by contrast, be actuated with very low forces because it is pressure-balanced or force-balanced.

For this purpose, the slide valve comprises a valve housing and a substantially axially symmetrical closing body arranged in longitudinally movable fashion in the valve housing. An inlet duct, a first outlet duct and a second outlet duct are formed in the valve housing. The closing body, by means of its longitudinal movement, interacts with a first valve seat formed in the valve housing and thereby opens and closes a first hydraulic connection between the inlet duct and the first outlet duct. The closing body furthermore, by means of its longitudinal movement, interacts with a second valve seat formed in the valve housing and thereby opens and closes a second hydraulic connection between the inlet duct and the second outlet duct. The resultant hydraulic force on the closing body in the axial direction is approximately zero; the closing body is thus pressure-balanced or force-balanced. In this way, only low forces are required to generate a longitudinal movement of the closing body. The closing body can thus be actuated in a very dynamic manner, and the slide valve can open and close the first hydraulic connection and the second hydraulic connection very quickly.

In advantageous embodiments, the first valve seat and the second valve seat are each designed as a slide valve seat. In this way, there is no need for high contact pressures such as for example in the case of a disk valve. Thus, the valve positions of the slide valve also do not require high closing forces. Accordingly, the required actuating forces on the closing body are very low in all operating situations.

A first closing cylinder and a second closing cylinder are advantageously formed on the closing body. Here, the first closing cylinder interacts with the first valve seat and the second closing cylinder interacts with the second valve seat. In this way, the slide valve, which is designed as a 3-way valve, is outlet-controlled. This is a very robust design, and it is not necessary for narrow tolerances to be adhered to in the manufacturing process.

In advantageous embodiments, the first closing cylinder has the same diameter as the second closing cylinder. This is a very simple and inexpensive design of a pressure-balanced closing body. The end-side surfaces which act in the axial direction and which acted on with fluid pressure—the projection surfaces—of the two closing cylinders thus have the same area.

In advantageous refinements, the first closing cylinder delimits a first valve chamber and the second closing cylinder delimits a second valve chamber. The projection surfaces of the first closing cylinder are accordingly acted on with the fluid pressure of the first valve chamber, and the projection surfaces of the second closing cylinder are acted on with the fluid pressure of the second valve chamber. In this way, the pressure balance on the closing body can be controlled by means of the pressures in the valve chambers. It is preferable for both projection surfaces to be of equal size, such that the fluid pressure in the first valve chamber can be selected to be equal to the fluid pressure in the second valve chamber.

It is advantageously the case that, for this purpose, the first valve chamber is hydraulically connected via a passage bore to the second valve chamber. It is thereby ensured that the fluid pressures in the two valve chambers are equal.

In an advantageous embodiment, the passage bore is formed in the closing body. In this way, the two valve chambers are hydraulically connected to one another in a very simple manner.

In advantageous refinements, a control bore opens into the first valve chamber or into the second valve chamber. It is accordingly possible for the pressure in the two valve chambers, which are preferably connected to one another via the passage bore, to be controlled via the control bore. Atmospheric pressure preferably prevails at the control bore, such that no additional measures have to be implemented in order to maintain a pressure difference with respect to the atmosphere or with respect to the surroundings.

The control bore is advantageously hydraulically connected to the second outlet duct. Here, it is preferable for a constant pressure, in particular atmospheric pressure, to prevail at the second outlet duct. A low, constant pressure on the projection surfaces is thereby ensured in a simple manner.

In advantageous embodiments, the longitudinal movement of the closing body is controllable by means of an actuator unit. In this way, the slide valve can be actively actuated.

In an advantageous refinement, the actuator unit comprises an electromagnet. In this way, the actuator unit can be of very space-saving design. Owing to the slide valve being force-balanced, a very small electromagnet can be used for it.

In an advantageous embodiment, the slide valve according to the invention is arranged in a waste-heat recovery system of an internal combustion engine. The waste-heat recovery system comprises a circuit that conducts a working medium, wherein the circuit comprises, in a flow direction of the working medium, a pump, an evaporator, a bypass valve, an expansion machine and a condenser. A bypass line is arranged in parallel with respect to the expansion machine, wherein the bypass valve controls the mass flow of the working medium to the expansion machine and to the bypass line. The bypass valve is the slide valve according to the invention. In this way, the mass flow of the working medium can be divided up between the expansion machine and the bypass line as desired. This may be performed for example in a manner dependent on the degree of evaporation of the working medium or in a manner dependent on the temperature of the working medium.

To realize high efficiency of the waste-heat recovery system, it is necessary to convey only evaporated working medium to the expansion machine. Liquid working medium must be conveyed through the bypass line. Fast switching between first and second hydraulic connection may thus be necessary; this may be performed with the slide valve according to the invention. The low energy consumption of the slide valve simultaneously increases the efficiency of the entire waste-heat recovery system.

The second outlet duct of the slide valve advantageously opens into the bypass line. A slide valve of said type then preferably has the control bore which is connected to the second outlet duct. The pressure at the second outlet duct is thus the pressure that prevails between expansion machine and evaporator, that is to say preferably atmospheric pressure. Said pressure thus acts in both valve chambers for the pressure equalization for the closing body.

### BRIEF DESCRIPTION OF THE DRAWINGS

FIG. 1 shows a longitudinal section through an exemplary embodiment of the slide valve according to the invention, wherein only the essential regions are illustrated.

FIG. 2 schematically shows the slide valve according to the invention within a waste-heat recovery system.

### DETAILED DESCRIPTION

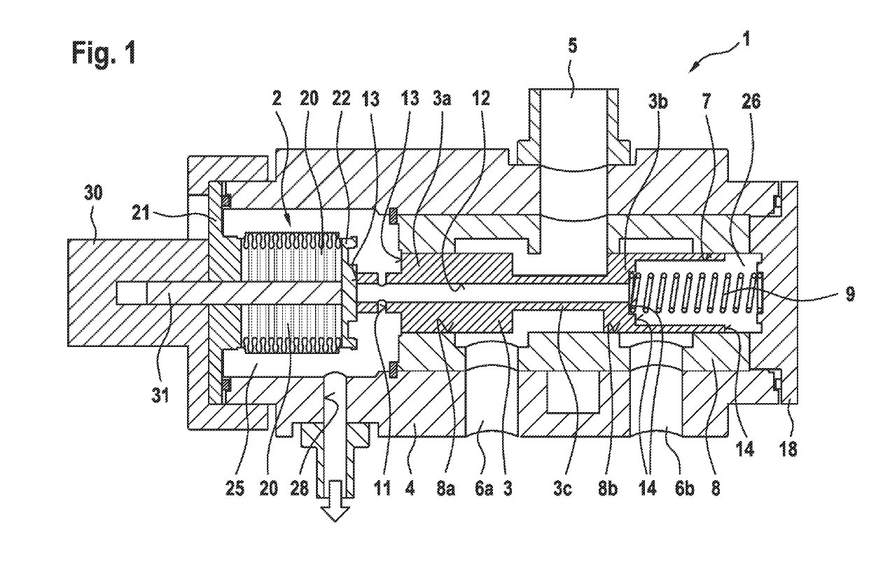

FIG. 1 shows a longitudinal section through a slide valve 1 according to the invention, wherein only the essential regions are illustrated. The slide valve 1 comprises a valve housing 4, a valve sleeve 8 which is arranged in, preferably pressed into, said valve housing, and a closing body 3, and is driven by a metal bellows-cylinder unit 2. Here, numerous alternative drives are possible, for example an electromechanical drive or a piezoelectric drive. An inlet duct 5, a first outlet duct 6a and a second outlet duct 6b are formed in the valve housing 4, such that, in this embodiment, the slide valve 1 is formed as a 3-way valve. In the valve sleeve 8 there is formed a guide bore 7, into which the inlet duct 5 and the two outlet ducts 6a, 6b open. In alternative embodiments, the valve sleeve 8 may also be omitted; accordingly, the guide bore 7 would then be formed in the valve housing 4.

The closing body 3 is arranged in longitudinally movable fashion in the guide bore 7 in order to open and close the two outlet ducts 6a, 6b. Here, the closing body 3 comprises a first closing cylinder 3a, a second closing cylinder 3b and a connecting pin 3c for connecting the two closing cylinders 3a, 3b. Here, the first closing cylinder 3a, the second closing cylinder 3b and the connecting pin 3c may be of unipartite form, or else of multi-part form. The closing body 3 is advantageously a substantially rotationally symmetrical form.

The metal bellows-cylinder unit 2 comprises a first cylinder 22, a second cylinder 21 and a metal bellows 20. The first cylinder 22 and the second cylinder 21 are arranged so as to be displaceable relative to one another in an axial direction, and are mechanically connected to one another by means of the metal bellows 20, and are sealed off to the outside by said metal bellows. The first cylinder 22 is arranged in longitudinally movable fashion substantially coaxially with respect to the guide bore 7. The second cylinder 21 is arranged rigidly with respect to the valve housing 4, for example by being screwed to or formed in one piece with said valve housing.

In the embodiment of FIG. 1, an actuator pin 31 is led through the second cylinder 21 and through the metal bellows 20. The actuator pin 31 interacts with the first cylinder 22, and the latter in turn interacts with the closing cylinder 3a. At the opposite side, a valve spring 9 interacts with the further closing cylinder 3b, such that the closing body 3 is braced between the actuator pin 31 and the valve spring 9. The actuator pin 31 is actuated by an actuator unit 30 (only schematically illustrated) and can thus, with the interposition of the first cylinder 22, move the closing body 3 counter to the force of the valve spring 9, that is to say to the right in the illustration of FIG. 1. The valve spring 9 acts as a compression spring, is arranged in a bore of the second closing cylinder 3b and is supported on a clamping nut 18. The clamping nut 18 is fixedly connected to the valve housing 4 or to the valve sleeve 8 so as to form a fixed stop for the valve spring 9.

The actuator unit 30 is advantageously an electromagnetic drive, wherein an electromagnet controls the actuator pin 31 in the longitudinal direction. Alternatively, the first cylinder 22 may however also be pneumatically or hydraulically controlled. In this case, no actuator pin 31 would be required; instead, the interior of the metal bellows 20 would be filled with a gas or fluid which would displace the first cylinder 22 under pressure.

The first closing cylinder 3a interacts with the first cylinder 22 of the metal bellows-cylinder unit 2. Alternatively, the first closing cylinder 3a and the first cylinder 22 may also be formed in one piece.

On the valve housing 4, or in the embodiment of FIG. 1 on the valve sleeve 8, there are formed a first valve seat 8a and a second valve seat 8b, wherein the first valve seat 8a surrounds the first outlet duct 6a and the second valve seat 8b surrounds the second outlet duct 6b. In the exemplary embodiment of FIG. 1, the first valve seat 8a and the second valve seat 8b are formed as subregions of the guide bore 7. The first closing cylinder 3a interacts with the first valve seat 8a and the second closing cylinder 3b interacts with the second valve seat 8b. The slide valve 1 is thus of outlet-controlled design, and controls the mass flows of the working medium at the outlet-side valve seats 8a, 8b.

The closing body 3 is pushed by the valve spring 9 to the left in the illustration of FIG. 1, counter to the thrust direction of the metal bellows-cylinder unit 2, and thereby opens a first hydraulic connection from the inlet duct 5 to the first outlet duct 6a and closes a second hydraulic connection from the inlet duct 5 to the second outlet duct 6b; this valve position is shown in the illustration of FIG. 1. When the actuator unit 30 is activated, the actuator pin 31 is pushed against the first cylinder 22 and thus indirectly pushes the closing body 3 counter to the spring force of the valve spring 9, that is to say to the right in the illustration of FIG. 1. In this way, the first closing cylinder 3a overlaps the first valve seat 8a and the second closing cylinder 3b opens up the second valve seat 8b, such that the first hydraulic connection is closed and the second hydraulic connection is opened. When the activation of the actuator unit 30 is ended, the metal bellows-cylinder unit 2 is compressed by the spring force of the valve spring 9, and the closing body 3 is pushed into the initial position again, such that the first hydraulic connection is opened and the second hydraulic connection is closed.

According to the invention, the slide valve 1 of FIG. 1 is of pressure-balanced design. For this purpose, a passage bore 12 and a connecting bore 11 are formed in the closing body 3. The passage bore 12 emerges from the substantially cylindrical closing body 3 at both ends of the latter, and opens at one end of the closing body 3 into a first valve chamber 25 and at the other end of the closing body 3 into a second valve chamber 26.

The first valve chamber 25 is delimited by the first closing cylinder 3a, the valve sleeve 8, the valve housing 4 and the metal bellows-cylinder unit 2. The second valve chamber 26 is delimited by the second closing cylinder 3b, the valve sleeve 8, and the clamping nut 18. The valve spring 9 is thus arranged in the second valve chamber 26.

The face-side surfaces, which delimit the first valve chamber 25, of the closing body 3 are referred to as first projection surfaces 13. The first projection surfaces 13 are formed substantially on the first closing cylinder 3a. The face-side surfaces, which delimit the second valve chamber 26, of the closing body 3 are referred to as second projection surfaces 14. The second projection surfaces 14 are formed substantially on the second closing cylinder 3b. Both projection surfaces 13, 14 are however always formed on the closing body 3.

The first valve chamber 25 is hydraulically connected via the passage bore 12 to the second valve chamber 26. In this way, the two projection surfaces 13, 14 on the two ends of the closing body 3 are acted on with the same fluid pressure.

In the axial direction of the closing body 3, the sum of the areas of the first projection surfaces 13 and the sum of the areas of the second projection surfaces 14 are equal. For this purpose, the diameters of the first closing cylinder 3a and of the second closing cylinder 3b are advantageously equal. Owing to the passage bore 12, the fluid pressure acting on both projection surfaces 13, 14 is equal, such that the resultant hydraulic force on the closing body 3 is zero; the closing body 3 is thus pressure-balanced or force-balanced.

A control bore 28 formed in the valve housing 4 also opens into the first valve chamber 25. The first valve chamber 25, and thus also indirectly via the passage bore 12 the second valve chamber 26, can be fed with fluid via the control bore 28. The control bore 28 is advantageously connected to the second outlet duct 6b, or a constant pressure, for example atmospheric pressure, prevails at said control bore.

The further surfaces of the closing body 3 that act in the axial direction, specifically in the region of the connecting pin 3c, are acted on with the fluid pressure of the inlet duct 5 and are accordingly also pressure-balanced or force-balanced. In alternative embodiments, the first closing cylinder 3a, the connecting pin 3c and the second closing cylinder 3b may have the same diameter, such that the closing body 3, in the region of the connecting pin 3c, has no surfaces which act in the axial direction.

Owing to the two points of contact between the first closing cylinder 3a and the first cylinder 22 and between the second closing cylinder 3b and the valve spring 9, there are smaller tolerances in the sum of the areas of the two projection surfaces 13, 14, because the respective contact surfaces are not acted on with fluid pressure. Said contact surfaces are however relatively small, such that the closing body 3 is substantially pressure-balanced or force-balanced.

The contact between the first closing cylinder 3a and the first cylinder 22 under some circumstances prevents a flow between the passage bore 12 and the first valve chamber 25. The connecting bore 11 is thus formed as a T-shaped bore or as a star-shaped bore relative to the passage bore 12, and opens into the first valve chamber 25.

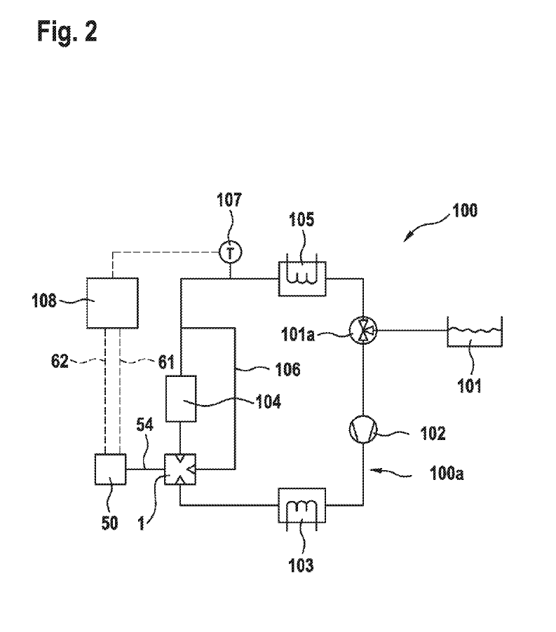

FIG. 2 shows a waste-heat recovery system 100 of an internal combustion engine 110 (not illustrated).

The waste-heat recovery system 100 has a circuit 100a, which conducts a working medium and which comprises, in a flow direction of the working medium, a feed fluid pump 102, an evaporator 103, an expansion machine 104 and a condenser 105. The working medium can be fed as required from a reservoir 101 into the circuit 100a via a branch line and a valve arrangement 101a. Here, the reservoir 101 may alternatively also be incorporated into the circuit 100a.

The evaporator 103 is connected to an exhaust line of the internal combustion engine, and thus utilizes the thermal energy of the exhaust gas of the internal combustion engine.

According to the invention, the slide valve 1, which is formed as a 3-way valve, is used as a bypass valve for the expansion machine 104. For this purpose, a bypass line 106 is arranged in parallel with respect to the expansion machine 104. Depending on the operating state of the internal combustion engine and resulting variables, for example temperatures of the working medium, the working medium is fed to the expansion machine 104 or is conducted past the expansion machine 104 through the bypass line 106. By way of example, a temperature sensor 107 is arranged upstream of the condenser 105. The temperature sensor 107 determines the temperature of the working medium upstream of the condenser 105 and transmits a corresponding signal to a control device 108. The control device 108 actuates the control unit 50 via the two electrical terminals 61, 62 in a manner dependent on various data, such as for example the temperature of the working medium upstream of the condenser 105.

The control unit 50 is connected via the connection line 54 to the slide valve 1 or to the actuator unit 30 thereof. The slide valve 1 is switched such that the working medium is conducted either through the expansion machine 104 or through the bypass line 106. The mass flow of the working medium may also be divided up, such that a part of the working medium is fed to the expansion machine 104 and a further part is fed to the bypass line 106.

The embodiments of the slide valve 1 according to the invention are very highly suited to use within a waste-heat recovery system 100 of an internal combustion engine, because the mass flow of the working medium can be divided up between the expansion machine 104 and the bypass line 106 quickly and in an energy-saving manner in a manner dependent on the operating state. The efficiency of the entire waste-heat recovery system 100 is thus increased.

1. A slide valve (1) having a valve housing (4) and having a substantially axially symmetrical closing body (3) arranged in longitudinally movable fashion in the valve housing (4), wherein an inlet duct (5), a first outlet duct (6a) and a second outlet duct (6b) are formed in the valve housing (4), wherein the closing body (3), by longitudinal movement, interacts with a first valve seat (8a) formed in the valve housing (4) and thereby opens and closes a first hydraulic connection between the inlet duct (5) and the first outlet duct (6a),
wherein the closing body (3) furthermore, by longitudinal movement, interacts with a second valve seat (8b) formed in the valve housing (4) and thereby opens and closes a second hydraulic connection between the inlet duct (5) and the second outlet duct (6b),
characterized in that the resultant hydraulic force on the closing body (3) in an axial direction is approximately zero.

2. The slide valve (1) as claimed in claim 1, characterized in that the first valve seat (8a) and the second valve seat (8b) are each configured as a slide valve seat.

3. The slide valve (1) as claimed in claim 1, characterized in that a first closing cylinder (3a) and a second closing cylinder (3b) are formed on the closing body (3), wherein the first closing cylinder (3a) interacts with the first valve seat (8a) and the second closing cylinder (3b) interacts with the second valve seat (8b).

4. The slide valve (1) as claimed in claim 3, characterized in that the first closing cylinder (3a) has the same diameter as the second closing cylinder (3b).

5. The slide valve (1) as claimed in claim 3, characterized in that the first closing cylinder (3a) delimits a first valve chamber (25) and in that the second closing cylinder (3b) delimits a second valve chamber (26).

6. The slide valve (1) as claimed in claim 5, characterized in that the first valve chamber (25) is hydraulically connected via a passage bore (12) to the second valve chamber (26).

7. The slide valve (1) as claimed in claim 6, characterized in that the passage bore (12) is formed in the closing body (3).

8. The slide valve (1) as claimed in claim 6, characterized in that a control bore (28) opens into the first valve chamber (25) or into the second valve chamber (26).

9. The slide valve (1) as claimed in claim 8, characterized in that the control bore (28) is hydraulically connected to the second outlet duct (6b).

10. The slide valve (1) as claimed in claim 1 and further comprising an actuator unit (30) configured to control longitudinal movement of the closing body (3).

11. The slide valve (1) as claimed in claim 10, characterized in that the actuator unit (30) comprises an electromagnet.

12. A waste-heat recovery system (100) having a circuit (100a) that conducts a working medium, wherein the circuit (100a) comprises, in a flow direction of the working medium, a pump (102), an evaporator (103), a bypass valve (1), an expansion machine (104) and a condenser (105), wherein a bypass line (106) is arranged in parallel with respect to the expansion machine (104), and wherein the bypass valve (1) controls a mass flow of the working medium to the expansion machine (104) and to the bypass line (106), characterized in that the bypass valve (1) is a slide valve (1) as claimed in claim 1.
